(19) United States
(12) Patent Application Publication
(10) Pub. No.: US 2026/0209995 A1
(43) Pub. Date: Jul. 23, 2026

(54) SPANDEX DRY-SPINNING STOCK SOLUTION CONTINUOUS REACTOR AND REACTION METHOD

(71) Applicant: ZHENGZHOU ZHONGYUAN SPANDEX ENGINEERING TECHNOLOGY CO., LTD, Zhengzhou, Henan Province (CN)

(72) Inventors: Yuewei CUI, Zhengzhou (CN); Yong LI, Zhengzhou (CN); Liwei MA, Zhengzhou (CN)

(21) Appl. No.: 19/144,636

(22) PCT Filed: Dec. 30, 2022
(86) PCT No.: PCT/CN2022/143702

§ 371 Date: Jun. 30, 2025

(51) Int. Cl. D01D 1/06; D01D 5/04; D01F 6/70

(52) U.S. Cl. CPC D01D 1/065; D01D 5/04; D01F 6/70; D10B 2331/10

(57) ABSTRACT

A continuous reactor for the spinning dope of dry-spun spandex and the a reaction method, where the reactor includes a housing and a rotor. The housing has a prepolymer feed inlet, a mixed amine feed inlet and a polymer outlet. The rotor includes a main shaft part and a mixing part. The diameter of the mixing part gradually decreases from the side near the prepolymer feed inlet to the side near the polymer outlet, and the gap between the mixing part on the side near the prepolymer feed inlet and the housing is less than 5 mm. The mixing part is sequentially provided with at least a first blade group and a second blade group in the direction of the decrease of its diameter, and the gap between the end of the first blade group far from the axis of the rotor and the housing is less than 5 mm.

### CROSS-REFERENCE TO RELATED APPLICATIONS

This application is the U.S. national stage of International Patent Application No. PCT/CN2022/143702, filed on Dec. 30, 2022, the disclosure of which is incorporated herein by reference in its entirety.

### TECHNICAL FIELD

The present invention relates to the field of elastic fiber production equipment, and specifically to the technical field of a continuous chain-extension reactor and reaction method for the reaction between the prepolymer of spandex and the mixed amine solution.

### BACKGROUND TECHNIQUE

In the production process of dry-spun spandex, the preparation of the spinning dope mainly includes two reaction processes. The first reaction is the process of producing the prepolymer, and the second reaction is the process of producing the polyurethane polymer. Among them, in the second reaction process, the reaction reagents usually include: 1. the prepolymer obtained from the first reaction; 2. a mixed amine solution including one or more aliphatic monoamine terminators and one or more aliphatic diamine chain extenders.

The reaction process between the prepolymer and the mixed amine solution is usually completed by a batch or continuous reactor. In the reactor, since the reaction between the prepolymer and the mixed amine occurs very quickly, and the molecular weight of the product is very high, the viscosity of the liquid in the reactor can usually increase from 20 poise to 1,200 to 1,400 poise within a few seconds. In addition, some by-products are also generated during the reaction process. These by-products are usually referred to as “hard-segment gels”. Technically speaking, it is not a typical “gel”, but it includes partially low-solubility polymers obtained from side reactions. Compared with the desired polyurethane polymer, it has abnormally long urea-based hard segments and abnormally short polyurethane soft segments, as well as a small amount of cyclic oligomers of MDI molecules and ethylenediamine. These by-products are mainly formed when the prepolymer solution comes into contact with the flow of the mixed amine solution. At the interface, many different polymer entities are quickly formed. Among them, the above-mentioned most difficult-to-dissolve polymer entities will precipitate and adhere to the metal surface they contact. These deposits are swollen by the solvent to form the so-called “hard-segment gels”.

Existing continuous polymerization reactors, such as the traditional spandex continuous reactor disclosed in CN102408532A, the mixed amine solution and the prepolymer solution are metered into the reaction chamber through a single through-shaft inlet, Among them, the mixed amine solution enters through the central tube, and the prepolymer solution flows in together around the periphery of the central tube. Therefore, at the coaxial inlet, a large amount of prepolymer solution comes into contact with the mixed amine solution. It is extremely easy to have local proportioning errors at the contact interface, resulting in the formation of “hard-segment gels”.

In addition, traditional reactors are large in structure and bulky in volume. The polymers produced by the reaction have high molecular weight and high viscosity. When the rotors with bulky mechanical structures rotate, they stir the high-viscosity polymers and generate high mechanical shear heat. Therefore, it is impossible to achieve high rotation speeds. Usually, the maximum rotation speed does not exceed 250 rpm, and the mixing effect is poor. When the prepolymer solution comes into contact with the mixed amine solution, the local proportion may deviate from the theoretical value, causing the molecular weight, viscosity, etc. of the reaction product to deviate from the preset values, further increasing the content of by-products such as “hard-segment gels”.

These by-products accumulate in the reactor, requiring the reactor to be shut down for cleaning. Moreover, between two cleanings, the accumulation of by-products will also lead to changes in the performance of the reactor. In some types of reactors, a manually operated mechanical cleaning device or scraper is provided at the reagent inlet. Its position allows for the periodic removal of the polymer hard-segment gels around the inlet while the reactor continues to operate. However, since the scraper occupies a large part of the cross-sectional area of the peripheral flow channel of the coaxial inlet during operation, backpressure disturbances and interruptions in the flow of the prepolymer solution will occur.

### CONTENTS OF THE INVENTION

In order to solve the above technical problems, the present invention provides a continuous reactor for the spinning dope of dry-spun spandex. It can realize the polymerization reaction with the precise proportioning of the prepolymer solution and the mixed amine solution, avoid the influence of by-products on the equipment and production, and reduce the mechanical heat generation at high rotation speeds. The specific solution is as follows:
A continuous reactor for the spinning dope of dry-spun spandex comprises a housing and a rotor. The housing is provided with a prepolymer feed inlet, a mixed amine feed inlet and a polymer outlet It is characterized in that the housing comprises a circumferential surface and at least one end surface. The rotor comprises a main shaft part and a mixing part. The main shaft part passes through the housing and is connected to a driving device. The mixing part is the part of the rotor inside the reactor cavity. The diameter of the mixing part gradually decreases from the side close to the prepolymer feed inlet to the side close to the polymer outlet, and the gap between the bottom surface of the mixing part and the end surface of the housing is less than 5 mm. The mixing part is sequentially provided with at least a first blade group and a second blade group in the direction of the decrease of its diameter.

Among them, the mixing part of the rotor can be roughly regarded as a “cone”. The “cone” means that the overall shape of the mixing part is roughly conical or frustum-shaped similar to a cone, that is, the mixing part has a side conical surface and two end surfaces. Specifically, in the direction of the decrease of its diameter, the geometric shape of the side conical surface of the mixing part can be a standard conical shape, that is, the waist line of the mixing part is a straight line; the side conical surface can also be a smooth curved surface, that is, the waist line of the mixing part is a curve; the side conical surface can also be stepped, that is, the waist line of the mixing part is a broken line. Overall, the diameter of the mixing part gradually decreases from the side close to the prepolymer feed inlet to the side close to the polymer outlet. In addition, in the present invention, unless otherwise specified, the end surface with a larger diameter of the mixing part is referred to as its “bottom surface”, and the part of the mixing part close to its bottom surface is referred to as its “bottom”. Similarly, the end surface with a smaller diameter of the mixing part is referred to as its “top surface”, and the part of the mixing part close to its end surface is referred to as its “top”. The “cavity” of the reactor is the space enclosed by the housing and used to accommodate the internal components of the reactor and the reaction liquid. The housing can include two end surfaces and a circumferential surface. Optionally, the rotation radius of each blade group gradually decreases in the direction close to the discharge port.

Optionally, the gap between the end of the first blade group far from the axis of the rotor and the circumferential surface of the housing is less than 5 mm.

Optionally, the prepolymer feed inlet faces the bottom surface of the mixing part.

In another optional embodiment, the prepolymer feed inlet can also be located on the circumferential surface of the housing. At this time, the position of the prepolymer feed inlet should be set on the side of the mixed amine feed inlet close to the bottom surface of the mixing part, so that a liquid film can be formed between the mixing part of the rotor and the housing for the prepolymer solution. In addition, the prepolymer and the mixed amine solution can also be fed coaxially. Under the condition that other features in the solution of the present invention remain unchanged, when the coaxial feeding method is adopted, the reaction effect of the reactor is still better than that of the traditional reactor However, since the prepolymer does not form a liquid film in advance, gels may still be generated at the feed inlet, and its reaction effect is worse than the preferred feeding method in the present invention.

Optionally, the mixed amine feed inlet is arranged on the circumferential surface of the housing.

Optionally, the prepolymer feed inlet is multiple feed inlets circumferentially distributed on the end surface of the housing.

Optionally, the mixed amine feed inlet faces the first blade group.

Optionally, the mixed amine feed inlet is located between the prepolymer feed inlet and the first blade group.

Optionally, the side of the first blade group close to the prepolymer feed inlet partially overlaps with the mixed amine feed inlet in the radial projection of the reactor.

The above several optional ways are all to ensure that the mixture of the prepolymer solution and the mixed amine solution can be divided and dispersed by the first blade group just after they come into contact, so as to achieve the purpose of precisely proportioning the prepolymer and the mixed amine. Since the mixed amine feed inlet is close enough to the first blade group, and the gap between the mixing part and the circumferential surface of the housing here is small and the liquid flow linear velocity is fast, the first blade group can disperse the mixed solution in time, avoiding local proportioning errors.

Optionally, the diameter of the mixed amine feed inlet is smaller than the width of a single blade in the first blade group.

Optionally, the distance between the first blade group and the bottom surface of the mixing part is greater than 5 mm.

Optionally, the housing is provided with a heat-insulating interlayer.

Optionally, a stator group is arranged in the reactor cavity, and the stator group is arranged between each blade group.

Optionally, the number of stators in each stator group is 4-16.

Optionally, the minimum gap between the stator and its adjacent blade is less than 5 mm.

The “minimum gap” refers to the minimum distance between the stator and the rotation surface of the blade.

Optionally, the minimum gap between the stator and the mixing part is less than 5 mm.

The minimum gap between the stator and the mixing part refers to the minimum distance between the end of the stator close to the mixing part and the side surface of the mixing part.

Optionally, the shape of the stator is plate-shaped.

Optionally, the plate-shaped stator is not perpendicular to the axis of the rotor.

Optionally, the diameter of the cavity gradually decreases from the prepolymer inlet to the polymer outlet.

Optionally, the mixing part is further provided with a third blade group in the direction of the decrease of its diameter.

Optionally, the number of blades in each blade group decreases sequentially.

Optionally, the number of blades in the first blade group is 4-50, the number of blades in the second blade group is 2-36, and the number of blades in the third blade group is 0-18.

Optionally, the mixed amine feed inlet is provided with a self-cleaning device.

Optionally, there are two mixed amine feed inlets.

Optionally, the self-cleaning device includes a cleaning device housing, a liquid inlet pipe, a porous pipe and a cleaning rod. The porous pipe is provided with a plurality of openings. The cleaning rod extends from the outside of the cleaning device housing into the porous pipe, and a handle is arranged on the cleaning rod outside the cleaning device housing.

A method for the chain-extension reaction of polyurethane carried out by the above-mentioned reactor is characterized by the following steps:
1) The prepolymer enters the reactor cavity through the prepolymer feed inlet, and a liquid film with a thickness of less than 5 mm is formed under the action of the housing and the bottom surface of the mixing part;
2) During the advancing process of the liquid film, the mixed amine solution is injected into the reactor cavity from the mixed amine feed inlet and meets the liquid film;
3) After the liquid film meets the mixed amine solution, the first blade group divides the mixture of the prepolymer and the mixed amine solution into multiple small units, and a preliminary reaction is carried out in the small units simultaneously;
4) The prepolymer and the mixed amine solution continuously advance under the pushing of the metering pump and the blades. During the advancing process, they are fully stirred by the blades at all levels, and the chain-extension reaction and the chain-termination reaction are completed to obtain the polymer, wherein the rotation speed of the blades is 300-3000 rpm;
5) The polymer after the reaction is pushed by the metering pump and the blades to leave the reactor through the polymer outlet.

### BENEFICIAL EFFECTS

The present invention provides a continuous reactor for the spinning dope of dry-spun spandex. Compared with the traditional reactor, the mixing part of the rotor in the reactor cavity of the present invention is conical, and the gap between the side of the mixing part close to the prepolymer feed inlet and the housing is defined. After the prepolymer enters the reactor cavity, a prepolymer liquid film is uniformly formed between the housing and the rotor, enabling more accurate proportioning with the mixed amine solution.

By defining the gap between the first blade group and the housing, and the relative positional relationship between the mixed amine feed inlet and the first blade group, when the liquid film advances to the first row of blades installed on the cone, it is divided into several small units by the blades and driven to rotate rapidly. Meanwhile, when encountering the mixed amine solution entering from the mixed amine feed inlet, the reaction between the prepolymer and the mixed amine solution is limited to each small unit. The proportioning of reactants in each unit is more accurate, avoiding the influence of gel polymers generated by local proportioning imbalance in the reactor cavity on subsequent reactions.

The conical mixing part of the rotor makes the number of blades, the rotation radius and the linear velocity of each blade group decrease step by step, reducing the mechanical heat generation caused by stirring the viscous polymer. This allows the equipment to be miniaturized and the rotation speed to be increased.

### DESCRIPTION OF DRAWINGS

1. Housing 11. First end surface of the housing 12. Second end surface of the housing 13. Circumferential surface of the housing 14. First stator group 15. Second stator group 16. Heat-insulating interlayer 17. Heat-insulating liquid inlet 18. Heat-insulating liquid outlet 2. Rotor 21. Main shaft part 22. Mixing part 23. First blade group 24. Second blade group 25. Third blade group 3. Prepolymer feed inlet 4. Mixed amine feed inlet 41. Self-cleaning device 42. Cleaning device housing 43. Mixed amine liquid inlet pipe 44. Porous pipe 45. Cleaning rod 46. Handle 5. Polymer outlet 6. Driving device

### SPECIFIC EMBODIMENTS

To make the objectives, technical solutions and advantages of the embodiments of the present invention clearer, the technical solutions in the embodiments of the present invention will be described more clearly and completely below in conjunction with the accompanying drawings. Apparently, the described embodiments are only a part of the embodiments of the present invention, rather than all of them. For the sake of clarity and conciseness, not all features of the actual implementation are described in the specification. To avoid obscuring the present invention with unnecessary details, only the device structures and processing steps closely related to the solution of the present invention are described in the accompanying drawings and the description, while the representation and description of the components and processes that are less relevant to the present invention and are known to those of ordinary skill in the art are omitted.

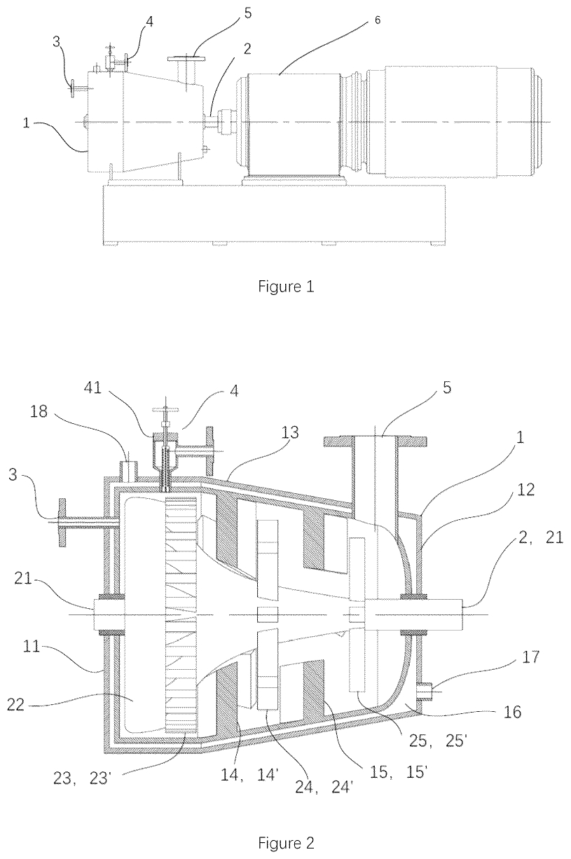

For the convenience of description, unless otherwise specified in the following text, the “upper”, “lower”, “left” and “right” are described based on the relative positions in FIG. 1. The prepolymer refers to the prepolymer solution obtained by the prepolymerization reaction of a diol compound and a diisocyanate compound; the mixed amine solution refers to substances such as small molecule diols, small molecule diamines, or a mixture of small molecule diamines and monoamines that undergo chain extension and chain termination reactions with the prepolymer in the production of spandex. The “mixed amine” is a general term for the mixed solution of the chain extender and the chain terminator in the polyurethane polymerization reaction for the convenience of description, and it can actually also include the chain extender and the chain terminator of alcohols; the polymer refers to the high molecular weight polyurethane compound obtained by the reaction of the prepolymer and the mixed amine solution. The gel refers to the high-viscosity by-product substance generated due to the local proportioning error of the prepolymer and the mixed amine solution or the excessive reaction caused by mechanical heat generation, and it also includes the “hard-segment gel” described above. The existence of the gel will affect the operation of the equipment and the subsequent reaction.

### Embodiment 1

This embodiment relates to a continuous reactor for the spinning dope of dry-spun spandex. As shown in FIGS. 1-2, the reactor includes a housing 1, a rotor 2. The housing is provided with a prepolymer feed inlet 3, a mixed amine feed inlet 4, a polymer outlet 5, and a driving device 6. As shown in FIG. 2, the housing 1 includes a first end surface 11 of the housing, a second end surface 12 of the housing and a circumferential surface 13 of the housing. The prepolymer feed inlet 3 is arranged on the first end surface 11 of the housing, and the mixed amine feed inlet 4 is arranged on the circumferential surface 13 of the housing. Wherein, the diameter of the prepolymer feed inlet 3 is Φ50 mm, the inner diameter of the mixed amine feed inlet 4 is Φ15 mm, the inner diameter of the polymer outlet 5 is Φ200 mm, the inner diameter of the first end surface 11 of the housing is Φ480 mm, the inner diameter of the second end surface 12 of the housing is Φ360 mm, the length of the inner cavity of the housing 1 is 560 mm. A cavity is formed inside the housing 1, and its free volume is approximately 45 liters. The inner diameter of the cavity gradually decreases from left to right. The prepolymer solution continuously enters the cavity through the prepolymer feed inlet 3 and the mixed amine solution continuously enters the cavity through the mixed amine feed inlet 4 at a flow rate of 1700 kg/hr and 1100 kg/hr respectively. After the polymer is formed by the reaction in the cavity, it leaves the reactor through the polymer outlet 5 and enters the next equipment.

In an optional embodiment, the prepolymer feed inlet 3 can also be multiple inlets evenly distributed along the circumference on the first end surface 11 of the housing. Preferably, the number of the inlets is 4, and the inner diameter of each inlet is Φ25 mm. The 4 feed inlets can be connected to a distribution valve in the form of one inlet and four outlets through pipelines.

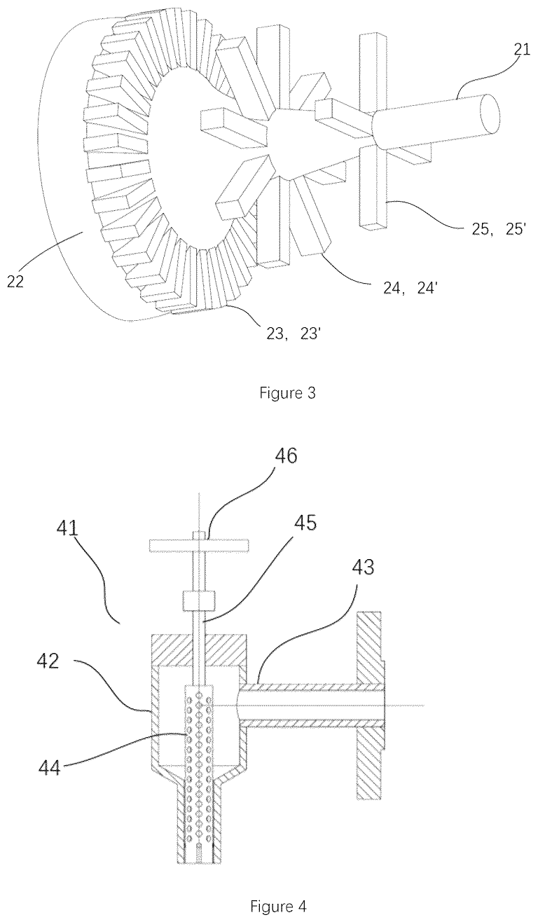

As shown in FIGS. 2 and 3, the rotor 2 includes a main shaft part 21 and a mixing part 22. The main shaft part 21 passes through the housing 1 from left to right and is connected to the driving device 6. In this embodiment, the driving device 6 is composed of components such as a motor, a coupling, and a bearing. In this embodiment, the motor is a synchronous motor with a power of 160 KW and a rotation speed of 1800 rpm. The mixing part 22 is the part of the rotor 2 inside the cavity. The main shaft part 21 and the mixing part 22 can be a fixed-connected whole, or two parts detachably connected in any known manner. In this embodiment, it is preferably that the two are a fixed-connected whole. The diameter of the mixing part 22 gradually decreases from left to right (that is, from the side close to the prepolymer feed inlet 3 to the side close to the polymer outlet 5). In the following text, unless otherwise specified, the side of the mixing part 22 close to the prepolymer feed inlet 3 is referred to as its bottom surface, and the side of the mixing part 22 close to the polymer outlet 5 is referred to as its top; the prepolymer feed inlet 3 faces the bottom surface of the mixing part 22, and the prepolymer feed inlet 3 deviates from the central position of the first end surface. The side conical surface of the mixing part 22 is a continuous smooth curved surface, and the gap between the bottom surface of the mixing part 22 and the first end surface 11 of the housing is 3 mm. This gap can make the prepolymer solution form a thin liquid film, so that the amount of prepolymer is small when it meets the mixed amine solution, which helps the prepolymer and the mixed amine solution to fully contact and avoids the problem of local proportioning errors between the two; the mixing part 22 is sequentially provided with a first blade group 23, a second blade group 24 and a third blade group 25 from left to right. The first blade group 23 has 30 first blades 23′, the second blade group 24 has 8 second blades 24′, and the third blade group 25 has 8 third blades 25′. Wherein, the outer diameter of the first blade group is Φ474 mm and is distributed along the circumference at intervals of 12°, The width of the blade is 54 mm. The first blades 23′ in the first blade group are embedded in the bottom of the mixing part 22 of the rotor. The distance between the left edge of the first blade group 23 and the bottom surface of the mixing part 22 is 50 mm. The gap between the end of the first blades 23′ of the first blade group 23 far from the axis of the rotor and the circumferential surface 13 of the housing is 2 mm. In this embodiment, it is preferable that there is a certain distance between the first blade group 23 and the bottom surface of the mixing part 22 to leave space for setting the mixed amine feed inlet 4 on the circumferential surface 13 of the housing, and to enable the prepolymer solution to meet the mixed amine solution in the liquid film state and be separated by the first blade group 23. In other optional embodiments, the first blade group 23 can also be flush with the bottom surface of the mixing part 22, and the mixed amine feed inlet 4 is set on the first end surface 11 of the housing, which can also make the materials more evenly mixed. However, this may cause gels to accumulate in the gap between the bottom surface of the mixing part 22 and the first end surface 11 of the housing. Therefore, the solution in this embodiment is most preferable; the second blade group 24 is composed of second blades 24′ with a width of 54 mm evenly distributed along the circumference, and its outer rotating diameter is Φ400 mm. The second blades 24′ are embedded in the middle part of the mixing part 22; the blades of the third blade group 25 have a width of 36 mm, and the outer rotating diameter is Φ300 mm. The third blades 25′ are embedded at the end of the mixing part 22. The power for the rotation of each blade group comes from the driving device 6 connected to the rotor 2 (not shown in the figure). Since the viscosity of the liquid in the reactor cavity gradually increases from left to right, the inner diameter of the reactor cavity and the outer rotating diameter of each blade group gradually decrease from left to right, which also reduces the motor power required for the rotor 2 to a certain extent. In an optional embodiment, the third blade group 25 can correspond to the center line of the discharge port 5 to assist the polymer solution to flow out from the polymer outlet 5.

In a preferred embodiment, the blades in the first blade group 23 and the second blade group 24 form an angle of 15° with the axis of the rotor 2, and the blades in the third blade group 25 form an angle of 30° with the axis of the rotor 2. The blades in each blade group forming a certain angle with the axis can not only play a role in stirring, but also have a certain pushing effect on the liquid in the cavity, promoting the liquid to move forward.

In the inner cavity of the housing 1, a first stator group 14 is arranged between the first blade group 23 and the second blade group 24, and a second stator group 15 is arranged between the second blade group 24 and the third blade group 25. Among them. the first stator group 14 has 12 plate-shaped stators 14′, and the second stator group 15 has 4 plate-shaped stators 15′. Wherein, each stator plate forms an angle of 20° with the axis of the rotor 2, the minimum gap between the rotation surface of each stator group and the adjacent blade group is 1 mm, and the minimum gap between each stator group and the mixing part 22 is 2 mm. The diameter of the cavity gradually decreases from left to right.

In order to avoid the influence of the temperature change in the cavity on the reaction, a heat-insulating interlayer 16 is also provided in the housing 1. Cold water, hot water, hot oil, etc. with a flow rate of 20 L/min can be used in the heat-insulating interlayer 16 for heating and cooling to adapt to the polymerization reaction of different polymer proportions. Correspondingly, a heat-insulating liquid inlet 17 and a heat-insulating liquid outlet 18 are provided on the housing 1.

In this embodiment, there are two mixed amine feed inlets 4, located at the higher point on the circumferential surface 13 of the housing. The liquid flow from the mixed amine solution supply pump is divided into two pipes with equal diameter and length to ensure that the flow rate to each mixed amine feed inlet is equal. The central axis of each mixed amine feed inlet 4 on the circumferential surface 13 of the housing is flush with the left edge of the first blade group 23. The mixed amine feed inlet 14 is also provided with a self-cleaning device 41 as shown in FIG. 4. The self-cleaning device 41 includes a cleaning device housing 42, a mixed amine solution inlet pipe 43, a porous pipe 44, and a cleaning rod 45. Among them, the mixed amine solution inlet pipe 43 is connected to the reactor housing I through the cleaning device housing 42. The porous pipe 44 is arranged in the cleaning device housing 42, one end of the porous pipe 44 is communicated with the reactor housing 1, and a plurality of openings are arranged on the pipe body of the porous pipe 44. The cleaning rod 45 extends from the outside of the cleaning device housing 42 into the porous pipe 44, and a handle 46 is arranged on the cleaning rod 45 outside the cleaning device housing 42. A scraping head can be arranged on the cleaning rod 45 in the porous pipe 44, or the diameter of the rod body is set to be consistent with the inner diameter of the porous pipe 44. The handle 46 can push the cleaning rod 45 into the reactor cavity, so as to scrape off the by-product gel attached to the inner wall of the porous pipe 44 and clean the porous pipe 44. The handle 46 can be manually operated, or connected to an automatic device to automatically push the cleaning rod 45 to clean the porous pipe 44 regularly. By performing the cleaning operation regularly, the by-product gel can be scraped off when the accumulation amount is small, effectively ensuring the smooth flow of the mixed amine solution feed, and trace amounts of gel debris will not have a substantial impact on the polymer solution. The aperture of each mixed amine feed inlet 4 is sufficient to deliver the required total flow of mixed amine solution into the reactor cavity. When one porous tube 44 is being cleaned, the other porous tube remains in normal operation. The two feed inlets perform cleaning actions alternately, thus ensuring that the cleaning process does not cause backpressure disturbance or flow interruption of the mixed amine solution.

The working process of the reactor in this embodiment is as follows:

When the reactor provided by the present invention is in operation, the inside of the reactor can be divided into three parts: area A, area B, and area C according to the flow direction of the liquid during operation. Among them, the area A is the feed and pre-mixing area of the reactor, including the prepolymer feed inlet 3, the mixed amine feed inlet 4, the bottom of the mixing part 22, and the first blade group 23, etc.; the area B is the mixing area of the reactor, including the first stator group 14 and the second blade group 24, etc.; the area C is the outlet area of the reactor, including the second stator group 15 and the third blade group 25, etc. During the operation of the reactor, the mixing intensity decreases sequentially from area A, area B to area C.

In area A, the prepolymer solution and the mixed amine solution meet here and complete the preliminary mixing under the action of the first blade group. The specific process is as follows:

The motor in the driving device 6 drives the rotor 2 to rotate at a high speed through transmission devices such as a coupling and a bearing. The prepolymer solution, one of the reaction materials, is accurately metered by a metering pump (not shown in the figure) and enters the reactor cavity through the prepolymer feed inlet 3 on the first end surface 11 of the housing. Under the centrifugal force of the rotor 2 and the pushing action of the metering pump, the prepolymer solution is continuously and uniformly pushed to the right along the smooth mixing part 22. Since the bottom of the mixing part 22 occupies most of the volume of area A, the prepolymer solution forms a flowing liquid film of the prepolymer solution on the surface of the mixing part 22 of the rotor. At the same time, the mixed amine solution is injected onto the side of the bottom edge of the mixing part 22 through the mixed amine feed inlet 4. In this area, the prepolymer and the mixed amine solution react extremely quickly. When the flowing prepolymer liquid film meets the jet flow of the mixed amine solution, it is sheared and divided into a large number of small-volume units by the first blade group 23 rotating at a speed of 1800 rpm, which helps the precise proportioning of the prepolymer solution and the mixed amine solution. At the same time, under the driving force of the prepolymer metering pump and the mixed amine solution metering pump, the reactants are quickly dispersed and pushed forward by the dense first blade group 23, avoiding the generation of by-product gels due to the local proportioning imbalance of the prepolymer solution and the amine solution at the mixed amine feed inlet 4, and further avoiding the influence of the by-product gels on the subsequent reaction.

The mixed amine feed inlet 4 occasionally has a backflow phenomenon, resulting in the blockage of the high-viscosity polymer liquid at the mixed amine feed inlet 4. Therefore, a self-cleaning device 41 is provided on the mixed amine feed inlet 4. The mixed amine solution enters through the mixed amine inlet pipe 43 and enters the reactor cavity through the porous pipe 44. The operator or the automatic device can regularly pull the handle 46 to drive the cleaning rod 45 to move back and forth in the porous pipe 44, so as to scrape off the high-viscosity polymer adhered to the inner wall of the porous pipe 44 and ensure the smooth flow of the mixed amine feed inlet 4. When one porous pipe 44 is being cleaned, the other porous pipe is in a normal working state, and the two feed inlets perform cleaning actions alternately, so as to ensure that the cleaning action will not cause backpressure disturbances or flow interruptions of the mixed amine solution flow. Preferably, the cleaning action is carried out at least 6 times per hour to prevent the by-product gel from accumulating in any mixed amine feed inlet.

After passing through the first blade group 23, the prepolymer solution and the mixed amine solution are preliminarily mixed and reacted, but the reaction is not complete. The nascent polymer obtained from the reaction increases the viscosity of the mixed liquid in the reactor and continues to flow to the right along the surface of the mixing part 22 and enters area B.

In area B, the blending of the nascent polymer is carried out, and the viscosity of the polymer continues to increase gradually in this area. The specific process is as follows:

When the nascent prepolymer formed in arca A passes through the second blade group 24 on the mixing part 22, the second blade group 24 stirs the mixed liquid in the cavity again, so that the unreacted NCO groups of the prepolymer are fully mixed and contacted with the NH₂ groups of the mixed amine solution and react. Since the diameter of the mixing part 22 at the second blade group 24 becomes smaller, and the diameter of the cavity also becomes smaller here, the stirring radius of the second blade group 24 also becomes smaller. Moreover, due to the small number of blades in the second blade group 24, the heat generated by stirring the viscous polymer by the second blade group 24 also decreases. Therefore, the rotation speed of the rotor can be increased, making the mixing more uniform and improving the mixing efficiency. At the same time, since the diameter of the mixing part 22 in area B is larger than that in area C, and the inner diameter of the cavity decreases, the linear velocity of the liquid in the cavity flowing from left to right in area B increases, thus reducing the residence time of the finished polymer moving from area B to the polymer outlet 5 in area C.

In area C, the mixed liquid after passing through the second blade group 24 has basically completed the reaction to obtain a polymer liquid. At this time, the viscosity of the obtained polymer liquid further increases. The polymer liquid continues to flow to the right along the surface of the mixing part 22 and passes through the third blade group 25, which not only helps the reaction to proceed more fully, but also helps the polymer liquid to flow out of the reactor from the polymer outlet. In addition, the polymer reaction in area C has been completed, and the product viscosity reaches the maximum. The third blade group 25 actually also plays a role in increasing the rotational resistance of the rotor 2. The main shaft part 21 of the rotor 2 can be connected to a torque measuring device outside the reactor, and the measurement result can be regarded as the resistance received by the third blade group 25, and the viscosity of the finished polymer solution can be measured by the magnitude of the torque. A temperature sensor and a pressure sensor are provided at the outlet of the reactor, and a polymer removal pump is connected to control the outlet pressure of the reactor to be stable. The temperature sensor can detect the change of the reaction temperature in real time and serve as one of the standards for the reaction degree and uniformity.

During the whole reaction process, in order to offset the tendency of the viscous polymer to follow and “climb” the rotating shaft of the rotor (i.e., the Weissenberg effect), in area B and area C, a first stator group 14 and a second stator group 15 are respectively arranged on the inner wall of the cavity. The two groups of stators are adjacent to the side surface of the mixing part 22, which can homogenize the mixed solution, change the flow direction and make the internal recirculation of the polymer substance, so that the mixing of the prepolymer and the mixed amine solution is more uniform and the reaction is more thorough; and the small gap between each stator and each blade group of the rotor 2 enables the mixed liquid to be fully extruded and sheared by the stator and the rotor when passing through the gap, making the mixing of the prepolymer and the mixed amine solution more uniform and the reaction more thorough. Each stator plate forms a certain angle with the axis of the rotor 2. This setting can not only make the flow direction of the liquid in the cavity more complex, but also reduce the volume of the stator while ensuring that the minimum gap between the stator and the rotor blades is small enough, playing a role in lightening the equipment.

The actual use effect of the reactor provided in this embodiment is as follows:

The prepolymer is dissolved in dimethylacetamide and continuously metered into the reactor per hour; the mixed amine required for the polymerization is also metered into the reactor per hour and dissolved in dimethylacetamide. The trial operation lasts for two weeks, and the prepolymer injection port is cleaned six times per hour. The final polymer is tested regularly, and the average results are as follows:
Intrinsic viscosity 1.0;
Primary amine end 15.0%;
Solid content 35.0%;

The volume viscosity calculated by the melt flow index is 2450 poise.

At the end of the test, the reactor is disassembled for cleanliness inspection, and there is no sign of hard-segment gel deposition at the mixed amine feed inlet and other places in the reaction chamber.

In summary, for the reactor provided in this embodiment, through the cooperation of the housing 1, the mixing part 22 and the first blade group 23, the mixed liquid of the prepolymer and the mixed amine solution is sheared and divided into a large number of small units, and the proportioning of the mixed liquid in each unit is more accurate, avoiding the problem of local proportioning imbalance; by setting the rotor 2 in the reactor cavity to be conical, the rotation radius of the blade is reduced, and at the same time, the shear linear velocity and shear radius of the viscous polymer are reduced, thereby reducing the mechanical stirring heat generation of the viscous polymer, enabling the rotation speed of the rotor to be increased and the mixing to be more uniform; compared with the traditional reactor, since the liquid in the reactor is required to pass through the gaps between various components in the form of a film during the flowing process, the equipment can be miniaturized and lightened; at the same time, the smaller rotation radius of the blade reduces the stirring resistance of the viscous material, enabling the rotation speed of the rotor to be increased to 1800 rpm, improving the stirring efficiency and reaction efficiency.

1. A continuous reactor for spinning dope dry-spun spandex comprising a housing and a rotor, wherein:
the housing comprises a prepolymer feed inlet, a mixed amine feed inlet, a polymer outlet, a circumferential surface, and at least one end surface; and
the rotor comprises a main shaft part and a mixing part, wherein:
the main shaft part passes through the housing and is connected to a driving device; and
the mixing part is inside the reactor cavity, wherein a diameter of the mixing part gradually decreases from a side adjacent to the prepolymer feed inlet to a side adjacent to the polymer outlet, and a gap between a bottom surface of the mixing part and the at least one end surface of the housing is less than 5 mm, the mixing part being sequentially provided with at least a first blade group and a second blade group in the direction of the decrease of the diameter of the mixing part.

2. The reactor according to claim 1, further comprising a gap between an end of the first blade group located distally from an axis of the rotor and the circumferential surface of the housing, wherein the gap is less than 5 mm.

3. The reactor according to claim 1, characterized in that the rotation radius of each blade group gradually decreases in the direction adjacent to the discharge port.

4. The reactor according to claim 1, characterized in that the prepolymer feed inlet faces the bottom surface of the mixing part.

5. The reactor according to claim 1, characterized in that the relative positional relationship between the mixed amine feed inlet and the first blade group satisfies one of the following manners:
1) the mixed amine feed inlet faces the first blade group;
2) the mixed amine feed inlet is located between the prepolymer feed inlet and the first blade group; or
3) the side of the first blade group adjacent to the prepolymer feed inlet partially overlaps with the mixed amine feed inlet in the radial projection of the reactor.

6. The reactor according to claim 1, characterized in that the diameter of the reactor cavity gradually decreases from the prepolymer inlet to the polymer outlet.

7. The reactor according to claim 1, characterized in that a stator group is arranged in the reactor cavity, and the stator group is arranged between each blade group.

8. The reactor according to claim 7, characterized in that the minimum gap between the stator and the mixing part is less than 5 mm, and the minimum gap between the stator and an adjacent blade is less than 5 mm.

9. The reactor according to claim 1, characterized in that the mixed amine feed inlet comprises a self-cleaning device, wherein the self-cleaning device comprises a cleaning device housing, a liquid inlet pipe, a porous pipe and a cleaning rod, and wherein:
the porous pipe has a plurality of openings;
the cleaning rod extends from the outside of the cleaning device housing into the porous pipe; and
a handle is arranged on the cleaning rod outside the cleaning device housing.

10. A method for performing a chain-extension reaction of polyurethane carried out by the reactor according to claim 1, comprising the following steps:
1) the prepolymer enters the reactor cavity through the prepolymer feed inlet, and a liquid film with a thickness of less than 5 mm is formed under the action of the housing and the bottom surface of the mixing part;
2) during the an advancing process of the liquid film, the mixed amine solution is ejected from the mixed amine feed inlet and meets the liquid film;
3) while the liquid film meets the mixed amine solution, the first blade group divides the mixture of the prepolymer and the mixed amine solution into multiple small units, and a preliminary reaction is carried out in the small units simultaneously;
4) the prepolymer and the mixed amine solution continuously advance under the pushing of the metering pump and the blades, and during the advancing process, the prepolymer and the mixed amine solution are fully stirred by the blades at all levels, and the chain-extension reaction and the chain-termination reaction are completed to obtain the polymer, wherein the rotation speed of the blades is 300-3000 rpm; and
5) the polymer after the reaction is pushed by the metering pump and the blades to leave the reactor through the polymer outlet.
